(19) United States
(12) Patent Application Publication
(10) Pub. No.: US 2023/0289961 A1
(43) Pub. Date: Sep. 14, 2023

(54) SYSTEM AND METHOD TO DETECT PLANT DISEASE INFECTION

(71) Applicant: BLU COCOON DIGITAL PRIVATE LIMITED, KOLKATA (IN)

(72) Inventors: Pinaki Bhattacharyya, Vestavia Hill, AL (US); Souvik Debnath, Bangalore (IN)

(21) Appl. No.: 18/169,245

(22) Filed: Feb. 15, 2023

(30) Foreign Application Priority Data
Mar. 2, 2022 (IN) 202231011178

(51) Int. Cl. G06T 7/00; G06T 5/00; G06T 5/40

(52) U.S. Cl. CPC G06T 7/0012; G06T 5/007; G06T 5/40; G06T 2207/30188

(57) ABSTRACT

A system to detect plant disease infection is disclosed. The plurality of subsystems includes an image receiving subsystem, configured to receive one or more images of plants as captured via image capturing devices. The plurality of subsystems includes an image contrast improving subsystem, configured to process the received one or more images of the plants using artificial intelligence-based image enhancing technique. The plurality of subsystems includes an image evaluation subsystem, configured to segregate the processed one or more images and evaluate the segregated one or more images to remove for image noise and unwanted objects. The plurality of subsystems includes a feature extraction subsystem, configured to extract one or more features from the evaluated one or more images. The plurality of subsystems includes an infection detection subsystem, configured to detect infected region and non-infected region based on the extracted one or more features.

### CROSS-REFERENCE TO RELATED APPLICATIONS

This Application claims priority from a patent application filed in India having Patent Application No. 202231011178 filed on Mar. 02, 2022 and titled “SYSTEM AND METHOD TO DETECT PLANT DISEASE INFECTION”.

### FIELD OF INVENTION

Embodiments of a present disclosure relates to infections detection systems, and more particularly to a system and a method to detect plant disease infection.

### BACKGROUND

The agricultural sector plays a strategic role during economic development of a country. Agricultural production provides employment opportunities to a very large percentage of the population. Hence, research and development in the agriculture field will not only help in increase in food productivity but also help in booming employment opportunities for countries population.

Conventionally, no system or process helps in detecting plant infections through naked eyes. Farmers or harvesters may detect in some known cases the plant infection through plant leaf colour problems. However, there is no effective method to normally detect plant infections with naked eyes.

Furthermore, in research labs with high resolution camera, scientists may easily detect any infection associated with the plants. However, implementation of such high-resolution cameras is not economical.

Hence, there is a need for an improved system to detect plant disease infection when visibility through naked eyes does not exist and a method to operate the same and therefore address the aforementioned issues.

### BRIEF DESCRIPTION

In accordance with one embodiment of the disclosure, a system to detect plant disease infection is disclosed. The system includes a hardware processor. The system also includes a memory coupled to the hardware processor. The memory comprises a set of program instructions in the form of a plurality of subsystems and configured to be executed by the hardware processor, wherein the plurality of subsystems comprises.

The plurality of subsystems includes an image receiving subsystem. The image receiving subsystem is configured to receive one or more images of plants grown in a specific area as captured via one or more image capturing devices. The plurality of subsystems also includes an image contrast improving subsystem. The image contrast improving subsystem is configured to process the received one or more images of the plants using artificial intelligence-based image enhancing technique.

The plurality of subsystems also includes an image evaluation subsystem. The image evaluation subsystem is configured to segregate the processed one or more images for colour of interests based on pixel value. The colour of interests comprises green, yellow, blue and brown. The image evaluation subsystem is also configured to evaluate the segregated one or more images to remove for image noise and unwanted objects.

The plurality of subsystems also includes a feature extraction subsystem. The feature extraction subsystem is configured to extract one or more features from the evaluated one or more images using artificial intelligence-based image feature extraction techniques. The one or more features comprises variance, energy, contrast, correlation, dissimilarity, and homogeneity.

The plurality of subsystems also includes an infection detection subsystem. The infection identification subsystem is configured to detect infected region and non-infected region based on the extracted one or more features.

In accordance with one embodiment of the disclosure, a method for detecting plant disease infection is disclosed. The method includes receiving one or more images of plants grown in a specific area as captured via one or more image capturing devices. The method also includes process the received one or more images of the plants using artificial intelligence-based image enhancing technique. The method also includes segregating the processed one or more images for colour of interests based on pixel value.

The method also includes evaluating the segregated one or more images to remove for image noise and unwanted objects. The method also includes extracting one or more features from the evaluated one or more images using artificial intelligence-based image feature extraction techniques. The method also includes detecting infected region and non-infected region based on the extracted one or more features.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram illustrating an exemplary computing system for detecting plant disease infection in accordance with an embodiment of the present disclosure;

FIG. 2A s an exemplary image of a wheat plant in accordance with an embodiment of the present disclosure;

FIG. 2B is an exemplary contrast enhanced image of the wheat plant in accordance with an embodiment of the present disclosure;

FIGS. 3 A-C are exemplary processed images of the wheat plant in accordance with an embodiment of the present disclosure;

FIG. 4 is an infection report presentation of the wheat plant in accordance with an embodiment of the present disclosure; and

FIG. 5 is a process flowchart illustrating an exemplary method for detecting plant disease infection in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises... a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

A computer system (standalone, client or server computer system) configured by an application may constitute a “subsystem” that is configured and operated to perform certain operations. In one embodiment, the “subsystem” may be implemented mechanically or electronically, so a subsystem may comprise dedicated circuitry or logic that is permanently configured (within a special-purpose processor) to perform certain operations. In another embodiment, a “subsystem” may also comprise programmable logic or circuitry (as encompassed within a general-purpose processor or other programmable processor) that is temporarily configured by software to perform certain operations.

Accordingly, the term “subsystem” should be understood to encompass a tangible entity, be that an entity that is physically constructed permanently configured (hardwired) or temporarily configured (programmed) to operate in a certain manner and/or to perform certain operations described herein.

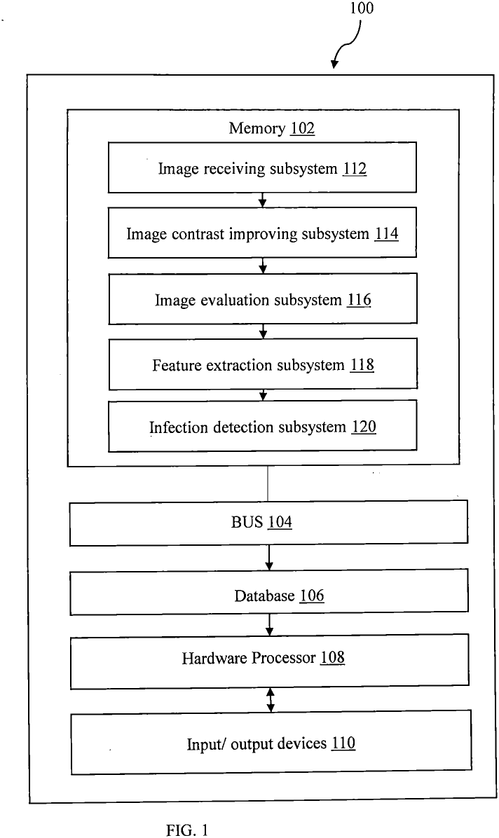

FIG. 1 is a block diagram illustrating an exemplary computing system 100 for detecting plant disease infection in accordance with an embodiment of the present disclosure. Plant pathogens pose significant challenges to the agricultural industry in many countries as the pathogens lead to destruction of crops and plants. Ultimately the global economic development of the country is hampered if the crops are destroyed. The computing system 100 identifies the crops and plants which are infected, and which are not infected. Examples of plant infection includes black spot, Powdery mildew, Downey mildew, blight and the like.

Specific plant crops have specific infection associated with them. Brinjal plant may be infected with Phomopsis Blight, leaf spot, wilt and the like. Cucumber plant may be infected with Downy mildew. Paddy plant with Sheath rot, False smut and the like. Potato plant may be infected with late blight, aphids and the like. The computing system 100 employs constant enhancement or contrast enhancement along with edge, cluster and probabilistic segmentation to detect whether a specific plant is infected or not.

The computing system 100 includes a hardware processor 108. The computing system 100 also includes a memory 102 coupled to the hardware processor 108. The memory 102 comprises a set of program instructions in the form of a plurality of subsystems and configured to be executed by the hardware processor 108. Input/output (I/O) devices 110 (including but not limited to keyboards, displays, pointing devices, etc.) can be coupled to the computing system 100 either directly or through intervening I/O controllers.

The hardware processor(s) 108, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 102 includes a plurality of subsystems stored in the form of executable program which instructs the hardware processor 108 via bus 104 to perform the method steps. The memory 102 has following subsystems: an image receiving subsystem 112, an image contrast improving subsystem 114, an image evaluation subsystem 116, a feature extraction subsystem 120 and an infection detection subsystem 122.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 108.

The plurality of subsystems includes an image receiving subsystem 112. The image receiving subsystem 112 is configured to receive one or more images of plants grown in a specific area as captured via one or more image capturing devices. In one specific embodiment, the one or more image capturing devices are positioned in a specific point associated with the plants and configured to take continuous images. The one or more image capturing devices covers a specific area of interest.

In such embodiment, the one or more image capturing devices includes mobile device image capturing device, handheld camera and the like. The one or more image capturing devices may capture single or multiple images of the associated plants. In such embodiment, the captured one or more images are inputted into the computing system 100.

The plurality of subsystems also includes an image contrast improving subsystem 114. The image contrast improving subsystem 114 is configured to process the received one or more images of the plants using artificial intelligence-based image enhancing technique. In one particular embodiment, the processing of the captured one or more images is performed using a contrast improvement and image size alignment technique.

In such embodiment, the artificial intelligence-based image enhancing technique includes Contrast Limited Adaptive Histogram Equalization (CLAHE) technique. Contrast limited adaptive histogram equalization (CLAHE) is used for improving the visibility level of foggy image or video.

In operation, contrast limited adaptive histogram equalization (CLAHE) is a variant of adaptive histogram equalization (AHE) which takes care of over-amplification of the captured one or more images contrast. Contrast limited adaptive histogram equalization (CLAHE) operates on small regions in the image, called tiles, rather than the entire image. The neighbouring tiles are then combined using bilinear interpolation to remove the artificial boundaries. As used herein, the term “contrast” is the degree of difference between two colours or between the lightest lights and darkest darks in the image. The contrast limited adaptive histogram equalization (CLAHE) overcomes the above drawback, by confining to specific regions instead of going global.

The image contrast improving subsystem 114 helps in resizing the image taken into image of 256 width and 256 lengths. In such embodiment, resizing the image includes no resampling. The image’s size is changed without changing the amount of data in that image. Resizing without resampling changes the image’s physical size without changing the pixel dimensions in the image. In such embodiment, no data is added to or removed from the image. In one specific embodiment, one or more interpolation techniques are being used to increase and decrease image size. The one or more interpolation techniques are INTER_AREA, INTER_CUBIC, INTER_LINEAR, INTER_NEAREST and the like.

The image contrast improving subsystem 114 also converts the captured image to Red Green Blue colour orientation from Blue Green red colour orientation. In such embodiment, the cvtColor function from OpenCV library is used to convert Red Green Blue colour orientation from Blue Green red colour orientation. The main difference between Red Green Blue colour orientation versus Blue Green red colour orientation is the arrangement of the subpixels for Red, Green, and Blue.

The plurality of subsystems also includes an image evaluation subsystem 116. The image evaluation subsystem 116 is configured to segregate the processed one or more images for colour of interests based on pixel value. As used herein, the term “pixel” (or picture element) is the smallest item of information in an image. Each of the pixels that represents an image captured has a pixel value which describes how bright that pixel is, or what colour the pixel should be. The colour of interests includes green, yellow, blue and brown. The pixel value is analysed based on red, green and blue channels. In such embodiment, the segregation is mainly done by applying either clustering based segmentation or probabilistic based. For example, the image segmentation is done using pixel values, like pixel value [130,163,120] is closest to pixel value [138,170,110] than pixel value [150,124,148]. In such exemplary embodiment, the prior cluster is chosen.

Computational values are measured between channels or tensors based on the thresholds identified. As used herein, the “tensors” are mathematical objects that may be used to describe physical properties and may be simply understood as an array.

In one exemplary embodiment, the yellow colour range is less than or below 0.8. In another exemplary embodiment, green colour range is from [47,75,52] to [200,225,23], yellow colour range is from [97,80,14] to [220,201,99], blue colour range is from [1,140,221] to [147,183,251] and brown colour range is from [44,77,64] to [147,113,86]. The range signifies that pixel values in between this range are more likely to be that particular colour.

The image evaluation subsystem 116 is also configured to evaluate the segregated one or more images to remove image noise and unwanted objects. Pixel values of unwanted objects are converted to [0,0,0] which is black colour. In such embodiment, Hue Saturation Value (HSV) model format are generated after evaluation of the segregated one or more images. Hue Saturation Value (HSV) is a cylindrical colour model that remaps the Red Green Blue primary colours into dimensions that are easier for humans to understand. Image noise is random variation of brightness or colour information in images and is usually an aspect of electronic noise.

The plurality of subsystems also includes a feature extraction subsystem 120. The feature extraction subsystem 120 is configured to extract one or more features from the evaluated one or more images using artificial intelligence-based image feature extraction techniques. The one or more features comprises variance, energy, contrast, correlation, dissimilarity, and homogeneity. In such embodiment, the features are extracted after the image contrast is improved and the image noise has been removed. Correlation measures the joint probability occurrence of the specified pixel pairs.

As used herein, the term “variance” provides idea about how the pixel values are spread across the image. As used herein, the term “energy” is a measure the localized change of the image. Homogeneity expresses how similar certain elements (pixels) of the image are.

In one embodiment, the artificial intelligence-based image feature extraction techniques may include Gray-level co-occurrence matrix (GLCM) algorithm. A Gray-level co-occurrence matrices (GLCMs) is a matrix that is defined over an image to be the distribution of co-occurring pixel values (grayscale values, or colors) at a given offset.

Gray-level co-occurrence matrix (GLCM) gives a measure of the variation in intensity at the pixel of interest. Gray-level co-occurrence matrix (GLCM) texture considers the relation between two pixels at a time, called the reference and the Neighbour pixel. Firstly, the computing system 100 calculates the Gray-level co-occurrence matrix given the angle and scale. Using the matrix, all the features such as variance, energy and the like are calculated. For implementation, the system 100 imports greycomatrix and greycocorps functions from skimage library.

In such embodiment, the Gray-level co-occurrence matrix (GLCM) algorithm has been used here for active angle measured between 0 to 150 and colour scale between 1 to 3. In such embodiment, by specifying the angle the computing system 100 also predicts at that angle and scale, what is the distance.

The plurality of subsystems also includes an infection detection subsystem 122. The infection detection subsystem 122 is configured to detect infected region and non-infected region via analysing the extracted one or more features. Any user of the computing system 100 may easily detect the plant condition though there is no visibility in naked eyes. The pre-stored non-infected plant database are stored in a database 106.

In such embodiment, for detecting infected region and non-infected region of the plants based on the extracted one or more features, the infection detection subsystem 120 is configured to compare the extracted one or more features with a pre-stored non-infected plant database. Based on the compared results, the infected region and the non-infected region is detected. In one exemplary embodiment, for the infected region, energy feature in greater than 0.4, Angular Second Momentum (ASM), feature is greater than 0.2, dissimilarity feature is greater than 35 and homogeneity feature is greater than 0.4. The Angular Second Momentum (ASM), also known as energy, is a measure of homogeneity of an image.

In another embodiment, by comparing the threshold pre-stored non-infected plant database, the computing system 100 may also predict the disease infection. The threshold value provided is totally based on exploratory analysis of the extracted features. K-nearest neighbours (KNN) algorithm is used on the extracted features to predict its healthiness. Few diseases such as yellow rust, crown and root rot, stem rust, loose smut and the like are predicted.

The plurality of subsystems also includes an infection monitoring subsystem. The infection monitoring subsystem is configured to monitor the detected infected region for aging.

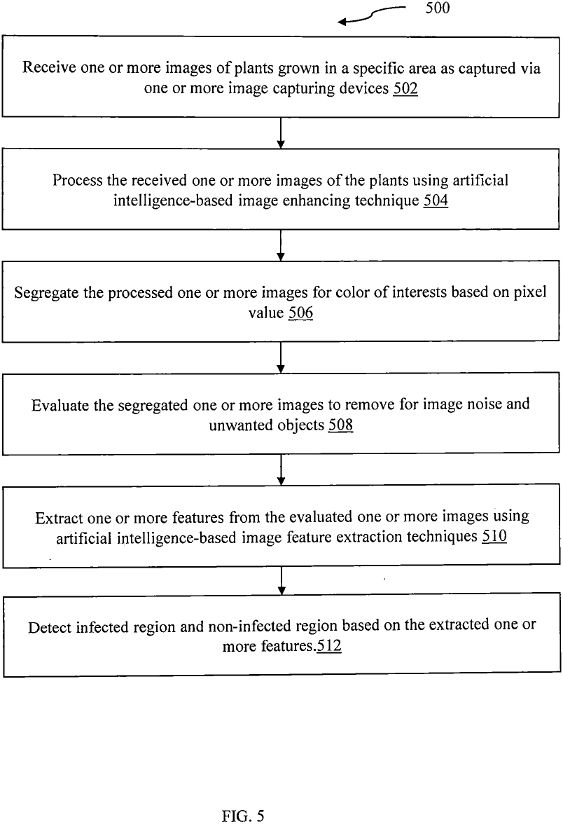

FIG. 2A is an exemplary image 202 of a wheat plant in accordance with an embodiment of the present disclosure. In one embodiment, a user with mobile device may capture an image of the wheat plant. The user inputs the image into the computing system 100. FIG. 2B is an exemplary contrast enhanced image 204 of the wheat plant in accordance with an embodiment of the present disclosure. In such embodiment, the contrast of the captured wheat image is improved by using artificial intelligence-based image enhancing technique.

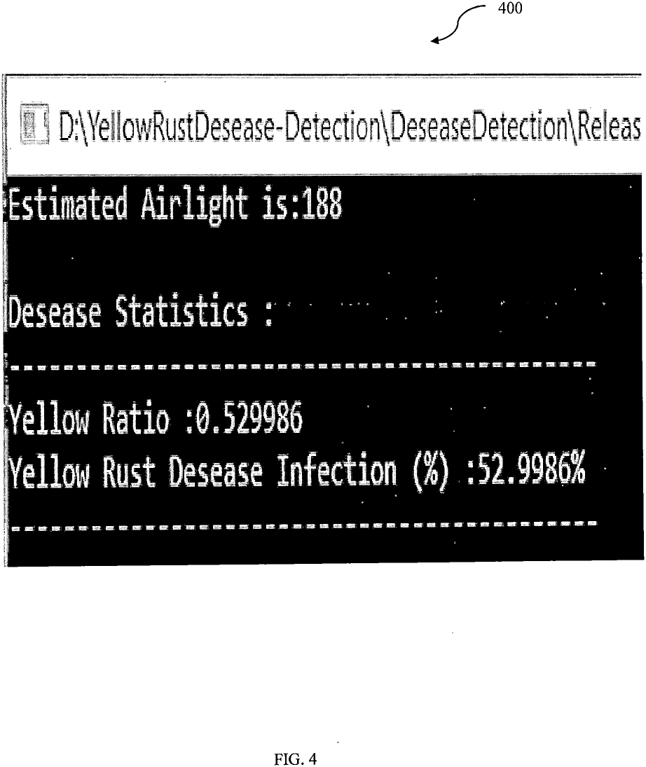

FIGS. 3 A-C is an exemplary processed image 302, 304 & 306 of the wheat plant in accordance with an embodiment of the present disclosure. In such embodiment, the wheat plant image is processed in accordance with pixel value. FIG. 3B is a masked image created using yellow range in Hue Saturation Value (HSV) channel. FIG. 3A is formed using bit-wise operation of masked image on original image with red, green blue orientation channel.

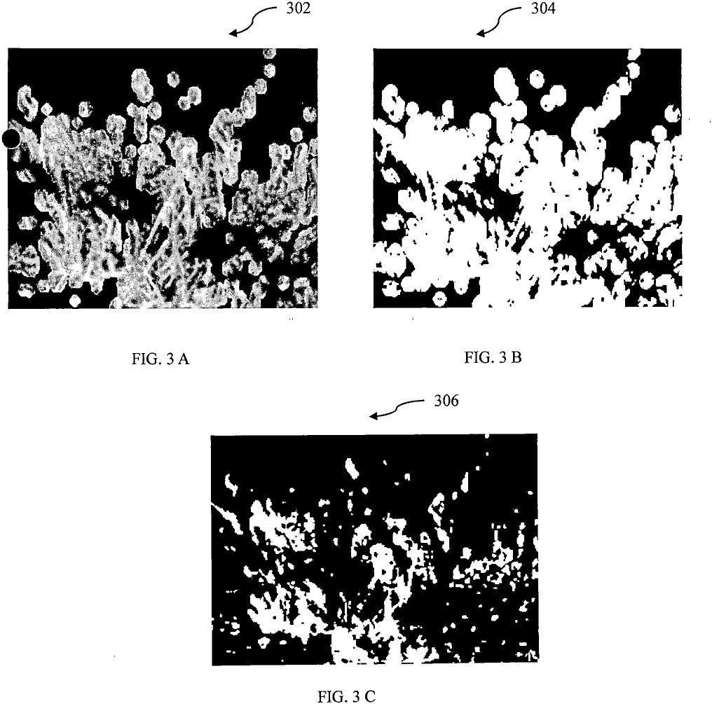

FIG. 4 is an infection report presentation of the wheat plant in accordance with an embodiment of the present disclosure. The report clearly indicates the plant is of yellow ratio is 0.529986. Hence, the computing system 100 detects that plant is infected, and based on the extracted features data the wheat plant may be suffering from yellow rust disease. Extracted features includes texture features such as Angular Second Momentum (ASM), energy, correlation and the like. Based on these features, the system 100 predicts whether the crop or the plant is infected or not.

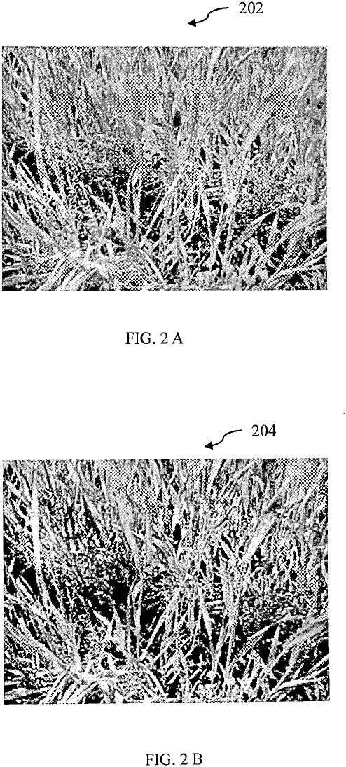

FIG. 5 is a process flowchart illustrating an exemplary method for detecting plant disease infection in accordance with an embodiment of the present disclosure.

In step 502, one or more images of plants grown in a specified area are received after capture via one or more image capturing devices. In one aspect of the present embodiment, the one or more images of plants grown in the specified area are received by an image receiving subsystem 112.

In step 504, the received one or more images of the plants are processed using artificial intelligence-based image enhancing technique. In one aspect of the present embodiment, the received one or more images of the plants are processed by the image contrast improving subsystem 114.

In step 506, the processed one or more images are segregated for colour of interests based on pixel value. In one aspect of the present embodiment, the processed one or more images for colour of interests based on pixel value by an image evaluation subsystem 116. The colour of interests comprises green, yellow, blue and brown.

In step 508, the segregated one or more images are evaluated to remove for image noise and unwanted objects. In one aspect of the present embodiment, the segregated one or more images are evaluated by the image evaluation subsystem 116.

In step 510, one or more features from the evaluated one or more images are extracted using artificial intelligence-based image feature extraction techniques. In one aspect of the present embodiment, one or more features from the evaluated one or more images are extracted by a feature extraction subsystem 118. The one or more features comprises variance, energy, contrast, correlation, dissimilarity, and homogeneity.

In step 512, infected region and non-infected region are detected via analysing the extracted one or more features. In one aspect of the present embodiment, infected region and non-infected region are detected by an infection identification subsystem 120.

In such embodiment, for detecting infected region and non-infected region of the plants based on the extracted one or more features, the method 500 includes comparing the extracted one or more features with a pre-stored non-infected plant database. The method 500 then detects infected region and non-infected region of the plants based on the compared results. The method 500 also includes periodically monitoring the detected infected region for aging.

The computing system 100 helps to detect plant disease infection which are not visible through naked eyes. The computing system 100 provides an easy and economical system that extract plant image features, which are judged to detect plant is infected or not. By comparing the threshold pre-stored value, the computing system 100 may also predict the disease infection associated with the plant in question.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (as shown in FIG. 1) (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system to detect plant disease infection, the system comprising:
a hardware processor; and
a memory coupled to the hardware processor, wherein the memory comprises a set of program instructions in the form of a plurality of subsystems, configured to be executed by the hardware processor, wherein the plurality of subsystems comprises:
an image receiving subsystem configured to receive one or more images of plants grown in a specific area as captured via one or more image capturing devices;
an image contrast improving subsystem configured to process the received one or more images of the plants using artificial intelligence-based image enhancing technique, wherein the processing of the captured one or more images comprises contrast improvement and image size alignment;
an image evaluation subsystem configured to
segregate the processed one or more images for colour of interests based on pixel value, wherein the colour of interests comprises green, yellow, blue and brown; and
evaluate the segregated one or more images to remove for image noise and unwanted objects;
a feature extraction subsystem configured to extract one or more features from the evaluated one or more images using artificial intelligence-based image feature extraction techniques, wherein the one or more features comprises variance, energy, contrast, correlation, dissimilarity, and homogeneity; and
an infection detection subsystem configured to detect infected region and non-infected region of the plants based on the extracted one or more features.

2. The system as claimed in claim 1, further comprising an infection monitoring subsystem configured to monitor the detected infected region for aging.

3. The system as claimed in claim 1, wherein the artificial intelligence-based image enhancing technique comprises Contrast Limited Adaptive Histogram Equalization (CLAHE) technique.

4. The system as claimed in claim 1, for detecting infected region and non-infected region of the plants based on the extracted one or more features, the infection detection subsystem is configured to:
compare the extracted one or more features with a pre-stored non-infected plant database; and
detect infected region and non-infected region of the plants based on the compared results.

5. A method for detecting plant disease infection, the method comprising:
receiving, by a processor, one or more images of plants grown in a specific area as captured via one or more image capturing devices;
processing, by the processor, the received one or more images of the plants using artificial intelligence-based image enhancing technique, wherein processing of the captured one or more images comprises contrast improvement and image size alignment;
segregating, by the processor, the processed one or more images for colour of interests based on pixel value, wherein the colour of interests comprises green, yellow, blue and brown;
evaluating, by the processor, the segregated one or more images to remove for image noise and unwanted objects;
extracting, by the processor, one or more features from the evaluated one or more images using artificial intelligence-based image feature extraction techniques, wherein the one or more features comprises variance, energy, contrast, correlation, dissimilarity, and homogeneity; and
detecting, by the processor, infected region and non-infected region based on the extracted one or more features.

6. The method as claimed in claim 5, further comprising periodically monitoring, by the processor, the detected infected region for aging.

7. The method as claimed in claim 5, the artificial intelligence-based image enhancing technique comprises Contrast Limited Adaptive Histogram Equalization (CLAHE) technique.

8. The method as claimed in claim 5, for detecting infected region and non-infected region of the plants based on the extracted one or more features, the method comprises:
comparing the extracted one or more features with a pre-stored non-infected plant database; and
detecting infected region and non-infected region of the plants based on the compared results.
